(19) United States
(12) Patent Application Publication
(10) Pub. No.: US 2011/0149472 A1
(43) Pub. Date: Jun. 23, 2011

(54) METHOD OF CONNECTING BUSBARS WITH CAPACITOR AND PRODUCT MANUFACTURED BY THE SAME METHOD

(75) Inventors: Chang-Hoon YANG, Chungcheongnam-Do (KR); Dae-Jin Park, Chungcheongnam-Do (KR); Yong-Won Jun, Cheonan-City (KR)

(73) Assignee: NUINTEK CO., LTD., Chungcheongnam-Do (KR)

(21) Appl. No.: 12/642,862

(22) Filed: Dec. 21, 2009

(51) Int. Cl. H01G 4/38; H01G 4/00

(52) U.S. Cl. 361/330; 29/25.41

(57) ABSTRACT

There is provided a method of connecting busbars for a capacitor and a product manufactured by the same method, whereby the inductance of the capacitor is decreased and thus the amount of heat generated in the capacitor is decreased to improve the temperature characteristics and electrical characteristics of the capacitor and the reliability of the quality of the capacitor, to consistently improve the insulation between the busbars having different polarity, and to maintain the insulation between the busbars in severe environments. The method of connecting busbars for a capacitor is characterized by coating at least parts of an N-pole busbar and a P-pole busbar, each of which has different polarity, with an insulating material; exposing parts of the N-pole and P-pole busbars outside an outer case so as to form a terminal to be connected to an other component; and connecting the N-pole busbar to the P-pole busbar in a manner that at least parts of the N-pole and P-pole is busbars overlap each other.

### BACKGROUND OF THE INVENTION

1. Field of the Invention

The present invention relates to a method of connecting busbars with capacitors to improve the performance of a capacitor, and more particularly, to a method of connecting busbars with capacitors, to improve the temperature characteristics and performance of the capacitor and the reliability of quality of the capacitor by decreasing the inductance of the capacitor to drop the surge voltage of an inverter and therefore decreasing the amount of heat generated in the capacitor.

2. Description of the Related Art

In general, case-molded type capacitor for electrical devices, phase advancers and electronic devices, among others, are widely used in various industrial fields.

In these capacitors, plastic films are used as dielectric materials. The plastic films may include plastic films, such as polyethylene terephthalate (PET) resin, polypropylene (PP) resin, polyethylene naphthalate (PEN) resin, polycarbonate (PC) resin and polyphenylene sulfide (PPS) resin, among others. One or both surfaces of the plastic film are deposited with metal, and the metal deposited film is wound. Then both surfaces of the wound metal deposited film are thermally sprayed with zinc, a zinc-base alloy, tin, or both zinc and tin (first spray with zinc and then spray with tin), thereby forming thermal sprayed surfaces to manufacture a capacitor device.

FIG. 3 and FIG. 4 illustrate a conventional capacitor assembly. Capacitor assembly has various capacitances to store an electrical charge, depending on their use. The capacitor assembly is manufactured by connecting the capacitor device(s) 400 (hereinafter, referred to as the ‘device’) to an N-pole busbar 100 and a P-pole busbar 200, each of which has different polarity, by increasing/decreasing the number of the devices 400. To manufacture a capacitor assembly having low capacitance, a small number of the devices 400 are connected. To manufacture a capacitor assembly having high capacitance, a great number of the devices 400 are connected.

In the capacitor comprising of a great number of the devices 400, the N-pole busbar 100 and the P-pole busbar 200 are connected to both of the thermal sprayed surfaces 700 of the devices 400, and parts of the N-pole busbar 100 and P-pole busbar 200 are exposed outside an outer case 900 (hereinafter, referred to as the ‘case’) to form a terminal 300.

After the whole of the devices 400 connected to the N-pole busbar 100 and the P-pole busbar 200 are placed into the case 900, such as a plastic case or a metal case, the case 900 is filled with a molding material, such as epoxy or urethane for insulation and protection of the inside of the capacitor, or the case 900 is filled with different kinds of molding materials, such as epoxy and urethane, in a multilayer manner, for insulation and protection of the inside of the capacitor.

However, in case of high-inductance, high-voltage in use, a flow of a great amount of current, or high-frequency, peripheral components of the capacitor are affected and heat is generated in the capacitor by serge voltage. The heat generated in the capacitor deteriorates the electrical characteristics of the capacitor, shortens the life time of the capacitor and decreases the reliability of the performance of the capacitor.

One of the reasons causing the aforementioned problems is based on the inductance of the capacitor.

Below, the constitution of a conventional capacitor and the process of manufacturing the same will be briefly described:

FIGS. 3 and 4 illustrate conventional capacitor assembly. As illustrated in FIG. 3, an N-pole busbar and a P-pole busbar, each of which has different polarity, are positioned in parallel, not to overlap each other, in a case 900. The N-pole busbar and the P-pole busbar are connected to devices 400. Only the terminal portion (300) are overlap each other. However, since the area overlapped by the N-pole and P-pole busbars is small, there is a limit in decreasing the inductance. In FIG. 4, an insulating material 800, such as an insulation paper, is inserted between an N-pole busbar and a P-pole busbar outside a case 900. As the insulating material 800 is additionally used, work is troublesome and it is difficult to consistently maintain the location of the insulating material 800. As the insulating material 800, an insulation paper or a plastic film is used. However, when the insulation paper is used, it absorbs moisture in severe environments (for example: at a temperature of 95° C., humidity of 85%), thereby insulation capability is weakened. When the plastic film is used, the properties of the plastic film are changed by hydrolysis, thereby affecting the capacitor. Therefore, to solve these problems, the present inventor(s) has invented a method of connecting busbars with different polarity for a capacitor, through a lot of trials and errors. The method of connecting busbars according to the present invention has remarkable effects of improving the performance of the capacitor and prolonging the life time of the capacitor.

### SUMMARY OF THE INVENTION

Therefore, it is an object of the present invention to provide a method of to connecting busbars with different polarity for a capacitor and a product manufactured by the same method, to improve the inductance of the capacitor by maximizing the area overlapped by the busbars, to prevent insulation capability from decreasing in severe environments when inserting an insulating material between the busbars, to increase the productivity by improving the troublesome work of inserting the insulating material, to greatly improve the electrical characteristics and reliability of the capacitor by decreasing the inductance, and to prolong the life of the capacitor.

In accordance with an embodiment of the present invention, there is provided a method of connecting busbars for a capacitor which is manufactured by connecting an N-pole busbar and a P-pole busbar, each of which has different polarity, to both thermal sprayed surfaces of a plurality of capacitor devices, connecting the N-pole busbar to the P-pole busbar so as to be insulated from each other, safely placing the N-pole and P-pole busbars connected to the devices in a case, and filling the inside of the case with a molding material, the method is characterized by: coating at least parts of the N-pole busbar and P-pole busbar with an insulating material, such as epoxy, so that the N-pole busbar and the P-pole busbar are electrically disconnected to each other; and assembling parts of the N-pole busbar and P-pole busbar so as to overlap each other, thereby improving the relevant work, improving the productivity, preventing the insulation capability from decreasing in severe environments, and decreasing the inductance.

Further, the N-pole busbar and the P-pole busbar may be connected to the devices in a zigzag shape (see FIG. 1C) so that the N-pole busbar and the P-pole busbar are alternated on each side surface of capacitor assembly, to thereby the inductance is reduced.

### BRIEF DESCRIPTION OF THE DRAWINGS

The above and other features and advantages of the present invention is will become more apparent to those of ordinary skill in the art by describing in detail preferred embodiments thereof with reference to the attached drawings in which:

FIG. 1A is a perspective view illustrating an N-pole busbar according to a first embodiment of the present invention;

FIG. 1B is a perspective view illustrating a P-pole busbar according to the first embodiment;

FIG. 10 is a perspective view illustrating a capacitor assembly according to the first embodiment;

FIG. 2A is a perspective view illustrating an N-pole busbar according to a second embodiment of the present invention;

FIG. 2B is a perspective view illustrating a P-pole busbar according to the second embodiment;

FIG. 2C is a perspective view illustrating a capacitor assembly according to the second embodiment;

FIG. 3 is a perspective view illustrating a conventional capacitor; and

FIG. 4 is a perspective view illustrating another conventional capacitor.

### DESCRIPTION OF REFERENCE NUMBERS OF MAJOR ELEMENTS

| | |
|---|---|
| 1: N-pole busbar | 2: P-pole busbar |
| 3: terminal | 4: capacitor device |
| 5: insulating material | 6: conductor |
| 7: thermal sprayed surface | 8: insulating material |
| 9: outer case | 10: lead frame |

### DETAILED DESCRIPTION OF THE PREFERRED EMBODIMENT

The present invention will now be described more fully hereinafter with reference to the accompanying drawings, in which preferred embodiments of the invention are shown. However, it is to be understood that the scope of the invention is not limited to the disclosed embodiments.

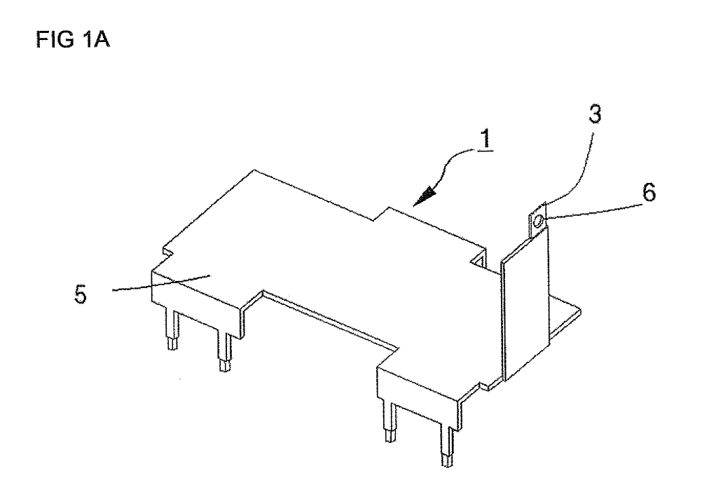

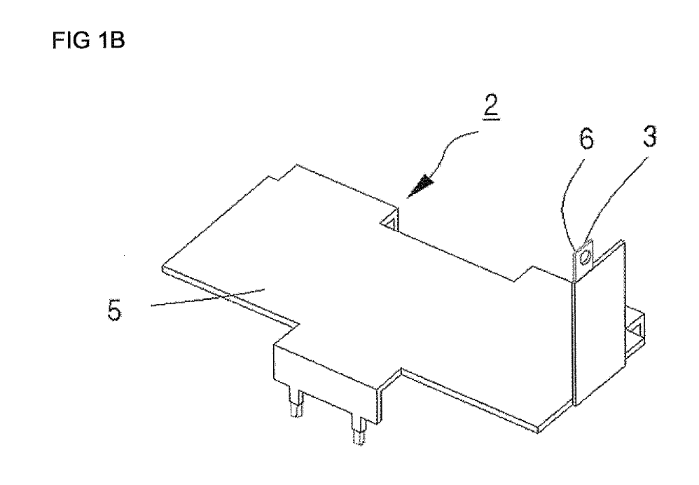

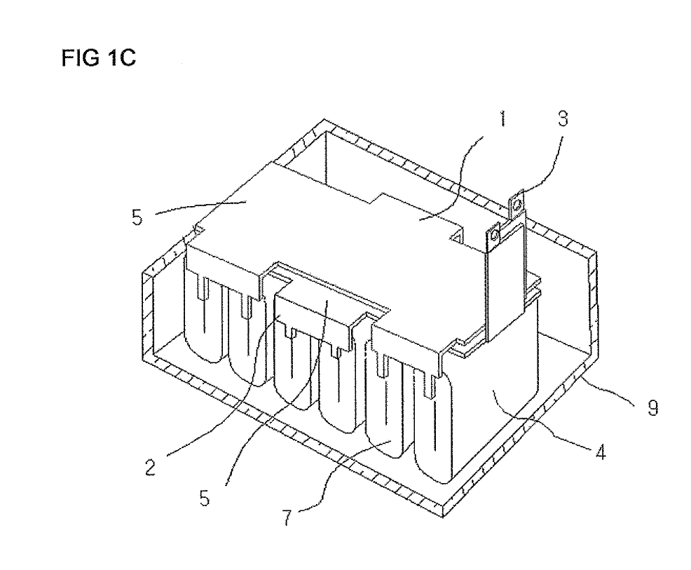

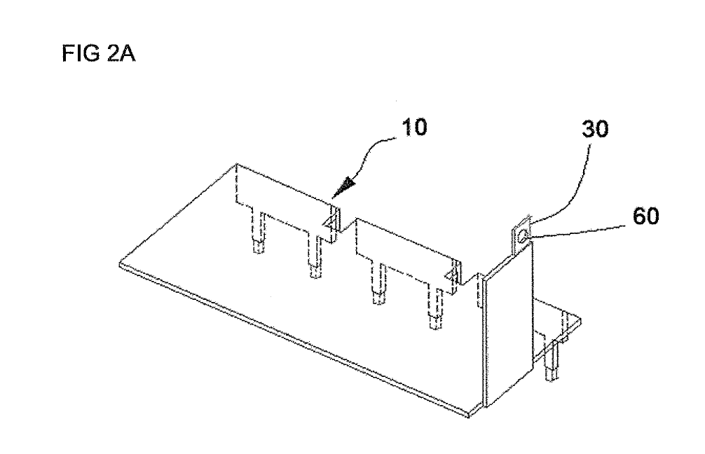

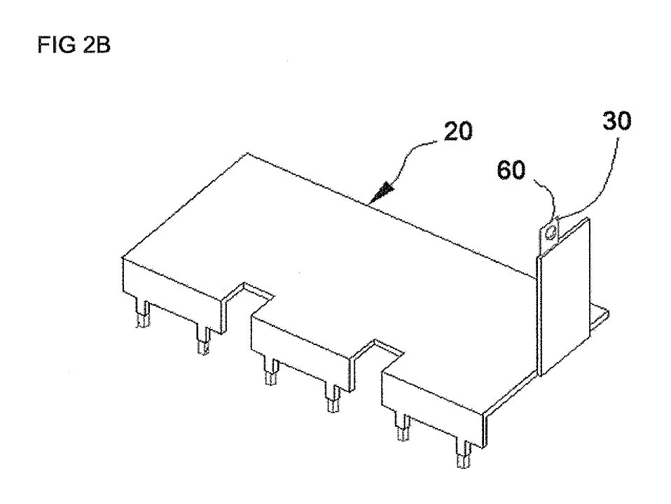

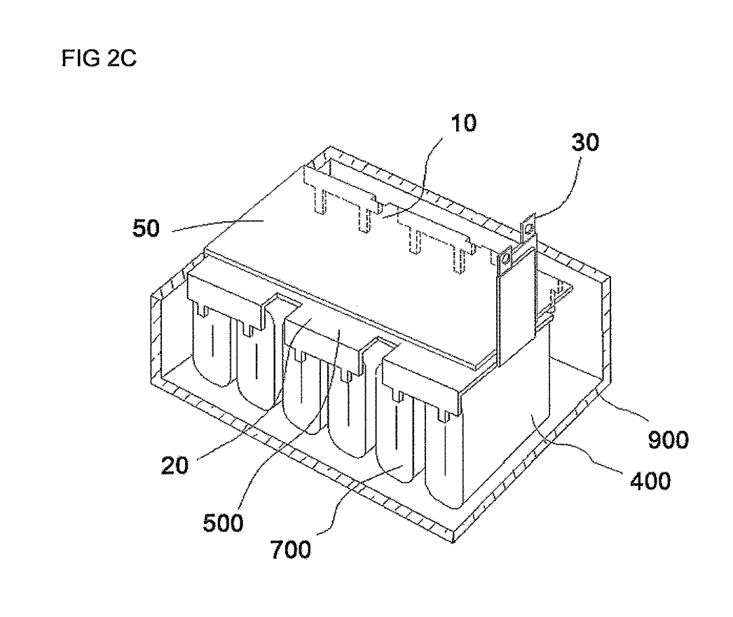

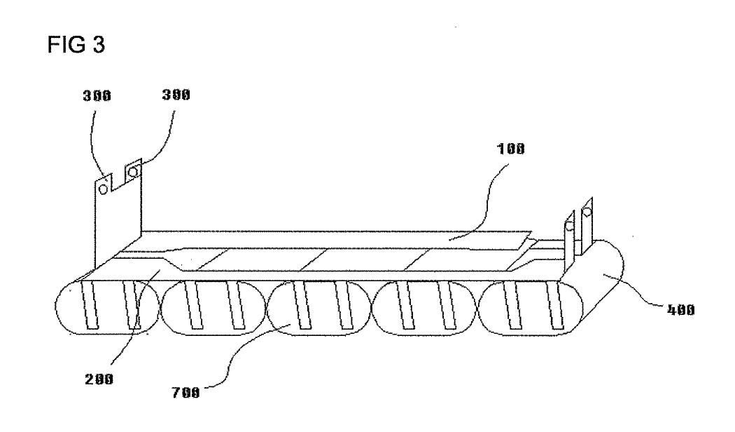

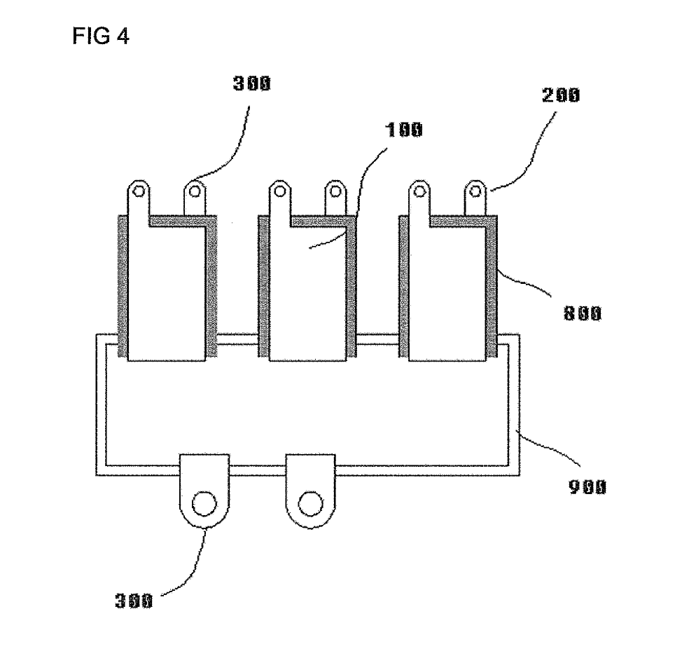

A method of connecting busbars for a capacitor and a product manufactured by the same method according to the present invention will be described, in detail, with reference to FIGS. 1A to 2C.

FIG. 1C is a perspective view illustrating the first embodiment of capacitor assembly which have connecting busbars illustrated in FIGS. 1A and 1B, and FIG. 2C is a perspective view illustrating the second embodiment of capacitor assembly which have connecting busbars illustrated in FIGS. 2A and 2B.

### Preferred Embodiment

As illustrated in FIG. 1C, at least parts of an N-pole busbar 1 and a P-pole busbar 2, each of which has different polarity, are coated with an insulating material 5, such as epoxy, to be provided with insulation capability. The N-pole busbar 1 and the P-pole busbar 2 are connected so that at least parts of the N-pole busbar 1 and P-pole busbar 2 overlap each other. The interaction of the overlapped busbars decreases the inductance of the capacitor, improves the insulation capability and increases the productivity by improving the workability.

The N-pole busbar 1 and the P-pole busbar 2 connected to the capacitor devices in a zigzag shape so that the N-pole busbar and the P-pole busbar are alternated on each side surface 7 (thermal spray surface) of capacitor assembly.

In other modified embodiments, an N-pole busbar 1 and a P-pole busbar 2 may be coated with an insulating material 5, such as urethane, they may be injection-coated with an insulator, such as plastic, or they may be wound with an insulator.

For reference, the aforementioned insulating material 5, such as epoxy or urethane, are described just as examples. Any one of various insulating materials may be selectively used.

In the drawings, the direction and the number of the busbars outside a case 9 may be variously selected at the intention of a manufacturer. In the present invention, the devices 4 connected to the N-pole busbar 1 and the P-pole busbar 2 are positioned in a parallel manner. However, the devices 4 may be connected in a series manner or in both a series and parallel manner.

As illustrated in FIG. 2C, at least parts of an N-pole busbar 10 and a P-pole busbar 20, each of which has different polarity, are coated with an insulating material 50, such as epoxy, to be provided with insulation capability. The N-pole busbar 10 and the P-pole busbar 20 are connected so that at least parts of the N-pole busbar 10 and P-pole busbar 20 overlap each other. The interaction of the overlapped busbars decreases the inductance of the capacitor, improves the insulation capability and increases the productivity by improving the workability.

The N-pole busbar 10 is connected to one thermal spray surface 70 of the capacitor devices, and the P-pole busbar 20 is connected to the other thermal spray surface 70 of the capacitor devices, which is opposite to the one thermal spray surface connected to the N-pole busbar 70.

In other modified embodiments, an N-pole busbar 10 and a P-pole busbar 20 may be coated with an insulating material 50, such as urethane, they may be injection-coated with an insulator, such as plastic, or they may be wound with an insulator.

For reference, the aforementioned insulating material 50, such as epoxy or urethane, are described just as examples. Any one of various insulating materials may be selectively used.

In the drawings, the direction and the number of the busbars outside a case 90 may be variously selected at the intention of a manufacturer. In the present invention, the devices 40 connected to the N-pole busbar 10 and the P-pole busbar 20 are positioned in a parallel manner. However, the devices 40 may be connected in a series manner or in both a series and parallel manner like as a first embodiment of the present invention.

In the present invention, the N-pole busbar 1,10 and the P-pole busbar 2,20 may be used, regardless of their thickness (for example, 0.01 mm˜several mm). The N-pole busbar 1,10 and the P-pole busbar 2,20 may use various conductors composed of a main material, such as copper or iron. The is insulating material 5,50 may be variously coated to a different coating thickness (for example, 0.01 mm˜several mm) according to the size and voltage of a capacitor. For an inductance test, a capacitor offering an electrical charge capacitance of 300 uF is used. The capacitor is manufactured by using a busbar which is 1 mm in thickness, and a film deposited with polypropylene (PP). The inductance test is performed in a conventional capacitor using the busbars illustrated in FIG. 3 (according to a first prior art), a capacitor using the busbars illustrated in FIG. 1C (according to a first embodiment of the present invention) and a capacitor using the busbars illustrated in FIG. 2C (according to a second embodiment). The results of the inductance test in each capacitor are as follows:

TABLE 1

| | inductance |
|---|---|
| Capacitor according to the first embodiment of the present | 60% |
| invention | |
| Capacitor according to the second embodiment of the present | 60% |
| invention | |
| Conventional capacitor according to the first prior art | 100% |

From [Table 1], the method of connecting busbars for a capacitor according to the first embodiment of the present invention decreases the inductance of the capacitor to 60%, compared with that of the first prior art. The method of connecting busbars for a capacitor according to the second embodiment of the present invention also decreases the inductance of the capacitor to 60%, compared with that of the first prior art. These results confirm that the method of connecting busbars according to the present invention is superior to the prior art.

In accordance with the present invention, as shown in [Equation 1] and [Equation 2], when the inductance decreases, the impedance decreases and is the amount of heat generated in the capacitor decreases, thereby greatly improving the performance and life of the capacitor.

The principles of decreasing the inductance are confirmed by [Equation 1] and [Equation 2].

As in [Equation 1] and [Equation 2], when the inductance is decreased, the impedance is decreased, thereby decreasing the amount of heat generated by resistance. Accordingly, the electrical characteristics of the capacitor are improved, thereby improving the reliability of the performance of the capacitor at a high temperature.

$$Z = R + ( WL - \frac{1}{WC} ) \qquad [ Equation 1 ]$$

Z[Ω]: impedance

R[Ω]: resistance

W: 2 μf

L: inductance

C: electrical charge capacitance of capacitor

J=I²Rt [Equation 2]

J: Joule heat

I: current

R: impedance, resistance

As described above, in the method of connecting busbars for a capacitor and a product manufactured by the same method according to the present invention, when the N-pole busbar 1,10 and P-pole busbar 2,20, each of which has different polarity, are connected to both thermal spray surfaces 7,70 of a plurality of devices 4,40, the N-pole busbar 1,10 and the P-pole busbar 2,20 are electrically disconnected to each other, thereby improving the insulation and preventing the insulation from decreasing in severe environments. Therefore, the work is improved and thus the productivity is improved. Furthermore, the N-pole busbar 1,10 and the P-pole busbar 2,20 are connected to each other in the manner that at least parts of the N-pole busbar 1,10 and P-pole busbar 2,20 overlap each other, thereby decreasing the inductance, thus improving the electrical characteristics and reliability of the capacitor, and prolonging the life of the capacitor.

The invention has been described using preferred exemplary embodiments. However, it is to be understood that the scope of the invention is not limited to the disclosed embodiments. On the contrary, the scope of the invention is intended to include various modifications and alternative arrangements within the capabilities of persons skilled in the art using presently known or future technologies and equivalents. The scope of the claims, therefore, should be accorded the broadest interpretation so as to encompass all such modifications and similar arrangements.

What is claimed is:

1. A method of connecting busbars for a capacitor which is manufactured by connecting an N-pole busbar and a P-pole busbar, each of which has different polarity, to both thermal spray surfaces of a plurality of capacitor devices, connecting the N-pole busbar and the P-pole busbar to each other so as to be insulated from each other, safely placing the N-pole busbar and the P-pole busbar in an outer case, and filling the inside of the outer case with a molding material,
the method characterized by:
coating at least parts of the N-pole busbar and P-pole busbar with an insulating material so as to be insulated from each other;
assembling at least parts of the N-pole busbar and P-pole busbar to each other so as to overlap each other; and
connecting the N-pole busbar and the P-pole busbar to the capacitor devices in a zigzag shape (so that the N-pole busbar and the P-pole busbar are alternated).

2. The method according to claim 1, wherein the insulating material is epoxy.

3. The method according to claim 1, wherein the insulating material is urethane.

4. The method according to claim 1, wherein the at least parts of the N-pole busbar and P-pole busbar are wound with an insulator so as to be insulated.

5. The method according to claim 1, wherein the at least parts of the N-pole busbar and P-pole busbar are injection-coated with an insulator.

6. The method according to claim 1, wherein the N-pole busbar is connected to one thermal spray surface of the capacitor devices, and the P-pole busbar is connected to the other thermal spray surface of the capacitor devices, which is opposite to the one thermal spray surface connected to the N-pole busbar.

7. The method according to claim 1, wherein the capacitor devices offering different capacitances are used.

8. A capacitor manufactured by the method according to claim 1.
